(19) United States
(12) Patent Application Publication
(10) Pub. No.: US 2013/0326350 A1
(43) Pub. Date: Dec. 5, 2013

(54) Methods and Systems for Facilitating User Refinement of a Media Content Listing

(71) Applicants: Brian F. Roberts, Dallas, TX (US); Donald H. Relyea, Dallas, TX (US)

(72) Inventors: Brian F. Roberts, Dallas, TX (US); Donald H. Relyea, Dallas, TX (US)

(73) Assignee: VERIZON PATENT AND LICENSING INC., Basking Ridge, NJ (US)

(21) Appl. No.: 13/484,727

(22) Filed: May 31, 2012

(51) Int. Cl. G06F 3/01

(52) U.S. Cl. 715/716

(57) ABSTRACT

An exemplary method includes a media content delivery system 1) presenting, within a media content listing interface, a graphical depiction of a slider disposed in between a first pole representative of a first media content characteristic and a second pole representative of a second media content characteristic, 2) determining, based on a position of the slider in between the first and second poles, a first weighted value for the first media content characteristic and a second weighted value for the second media content characteristic, 3) selecting, based on the first and second weighted values, a subset of media content instances from a plurality of media content instances available for access by way of an access device for inclusion in a media content listing, and 4) presenting display elements representative of the subset of media content instances within the media content listing interface. Corresponding methods and systems are also disclosed.

### BACKGROUND INFORMATION

As media content providers have expanded and continue to expand the media content choices available to users by way of set-top box devices, mobile devices, and other types of media content access devices (“access devices”), it has become more difficult for users of such devices to locate media content that actually interests the user. For example, a user may have access to thousands of television programs, on-demand movies, user-created videos (e.g., YouTube videos), trailers, news clips, and songs by way of a set-top box device, but be interested in only a small fraction of these media content instances at any given time.

To address this issue, various technologies have been developed that allow a user to access filtered media content listings (i.e., media content listings that do not include all of the media content instances available by way of an access device). For example, a user may perform a keyword search in order to be presented with a media content listing that includes only those media content instances that are related to one or more keywords provided by the user. As another example, a recommendation engine may automatically select various media content instances for inclusion in a media content listing presented to the user based one or more preferences, viewing habits, and/or listening habits of the user.

Unfortunately, it may still be difficult for a user to locate a desired media content instance within a filtered media content listing. For example, a user of a set-top box device may think that she is in the mood for a relatively short video clip as opposed to a full-length movie, but may still want to be presented with some full-length movie options just in case she changes her mind. Hence, it may be desirable for the user to be able to further refine a filtered media content listing by directing the set-top box device to include more short video clips than full-length movies in the filtered media content listing. Unfortunately, such customized refinements to media content listings are currently difficult, cumbersome, and sometimes impossible to perform.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary media content delivery system according to principles described herein.

FIGS. 2-3 illustrate an exemplary media content listing interface according to principles described herein.

FIG. 4 illustrates an exemplary implementation of the system of FIG. 1 according to principles described herein.

FIG. 5 illustrates an exemplary method of facilitating user refinement of a media content listing according to principles described herein.

FIG. 6 illustrates another exemplary method of facilitating user refinement of a media content listing according to principles described herein.

FIGS. 7-9 illustrate various examples of media content listing interfaces according to principles described herein.

FIG. 10 illustrates an exemplary computing device according to principles described herein.

### DETAILED DESCRIPTION OF PREFERRED EMBODIMENTS

Methods and systems for facilitating user refinement of a media content listing are described herein. As will be described below, a media content delivery system may 1) present, within a media content listing interface, a graphical depiction of a slider disposed in between a first pole representative of a first media content characteristic and a second pole representative of a second media content characteristic, 2) determine, based on a position of the slider in between the first and second poles, a first weighted value for the first media content characteristic and a second weighted value for the second media content characteristic, 3) select, based on the first and second weighted values, a subset of media content instances from a plurality of media content instances available for access by way of an access device for inclusion in a media content listing, and 4) present display elements representative of the subset of media content instances within the media content listing interface.

As will be described herein, the graphical depiction of the slider included in the media content listing interface may allow a user to refine or “fine tune” a media content listing presented within the media content listing interface with analog-like precision. For example, if the user is more interested in accessing media content instances that have (or are more in line with) the first media content characteristic as opposed to the second media content characteristic, the user may simply reposition (i.e., move) the slider closer to the first pole. In response, the media content delivery system may increase the weighted value for the first media content characteristic and decrease the weighted value for the second media content characteristic, select a new subset of media content instances for inclusion in the media content listing based on the adjusted weighted values, and present display elements representative of the new subset of media content instances within the media content listing interface.

As used herein, the terms “media content” and “media content instance” may refer to any media content program, television program, on-demand media program, pay-per-view media program, broadcast media program (e.g., broadcast television program), multicast media program (e.g., multicast television program), narrowcast media program (e.g., narrowcast video-on-demand program), IPTV media content, advertisement, video, movie, video clip, audio program, radio program, or any segment, component, or combination of these or other forms of media content that a user may access by way of an access device (e.g., a set-top box device, a mobile device, etc.).

As used herein, “a media content listing” may include any listing of media content instances available by way of an access device. For example, a media content listing may include a filtered media content listing (e.g., a search results listing, a recommended media content listing, etc.), a program guide listing, a watchlist, and/or any other suitable listing of media content instances. As will be illustrated below, a media content listing may be presented in the form of a plurality of display elements each representing a particular media content instance included in the media content listing. As used herein, a “display element” may include text (e.g., one or more words, characters, numbers, symbols, etc.), one or more images, one or more graphics, animation content (e.g., Flash content), one or more hyperlinks, and/or any other content that may be visually depicted within a media content listing interface and that may be representative of or otherwise provide access to a media content instance.

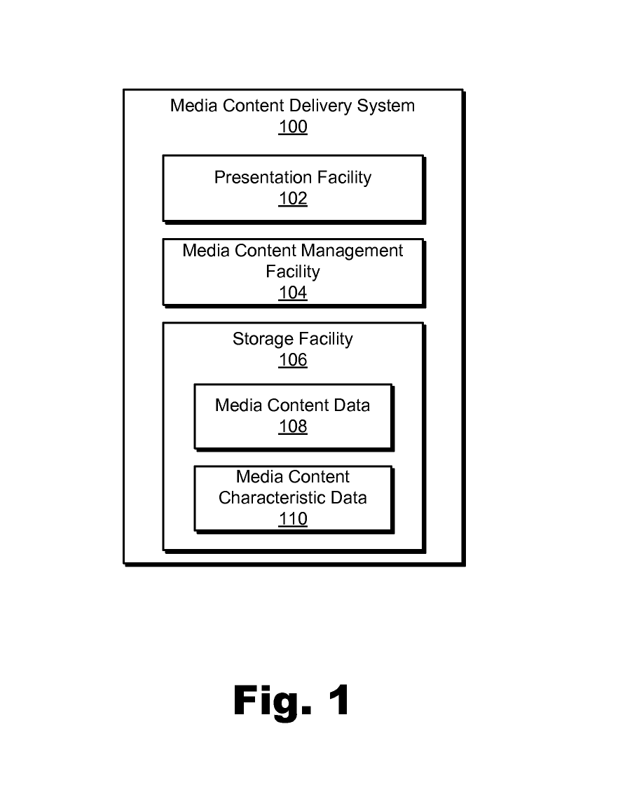

FIG. 1 illustrates an exemplary media content delivery system 100 (“system 100”). As shown, system 100 may include, without limitation, a presentation facility 102, a media content management facility 104, and a storage facility 106 selectively and communicatively coupled to one another. It will be recognized that although facilities 102-106 are shown to be separate facilities in FIG. 1, any of facilities 102-106 may be combined into fewer facilities, such as into a single facility, or divided into more facilities as may serve a particular implementation.

Presentation facility 102 may be configured to present one or more graphical user interfaces (“GUIs”) for experiencing by a user. For example, presentation facility 102 may be configured to present a media content listing interface configured to provide a user with access to a list of media content instances available by way of an access device.

Presentation facility 102 may be configured to present a media content listing interface (and any of the other GUIs, graphical depictions, and display elements described herein) in any suitable manner. For example, in cases wherein presentation facility 102 is implemented by the access device itself (e.g., a set-top box device or a mobile device), presentation facility 102 may present the media content listing interface by displaying (or directing a display device associated with the access device to display) the media content listing interface. Alternatively, in cases wherein presentation facility 102 is implemented by one or more computing devices other than the access device (e.g., by a media content provider subsystem communicatively coupled to the access device by way of a network), presentation facility 102 may present the media content listing interface by directing the access device (e.g., a set-top box device) and/or a companion device utilized by the user (e.g., a mobile device) to present or display the media content listing interface.

In some examples, presentation facility 102 may be further configured to present, within a media content listing interface, a graphical depiction of a slider disposed in between a first pole representative of a first media content characteristic and a second pole representative of a second media content characteristic.

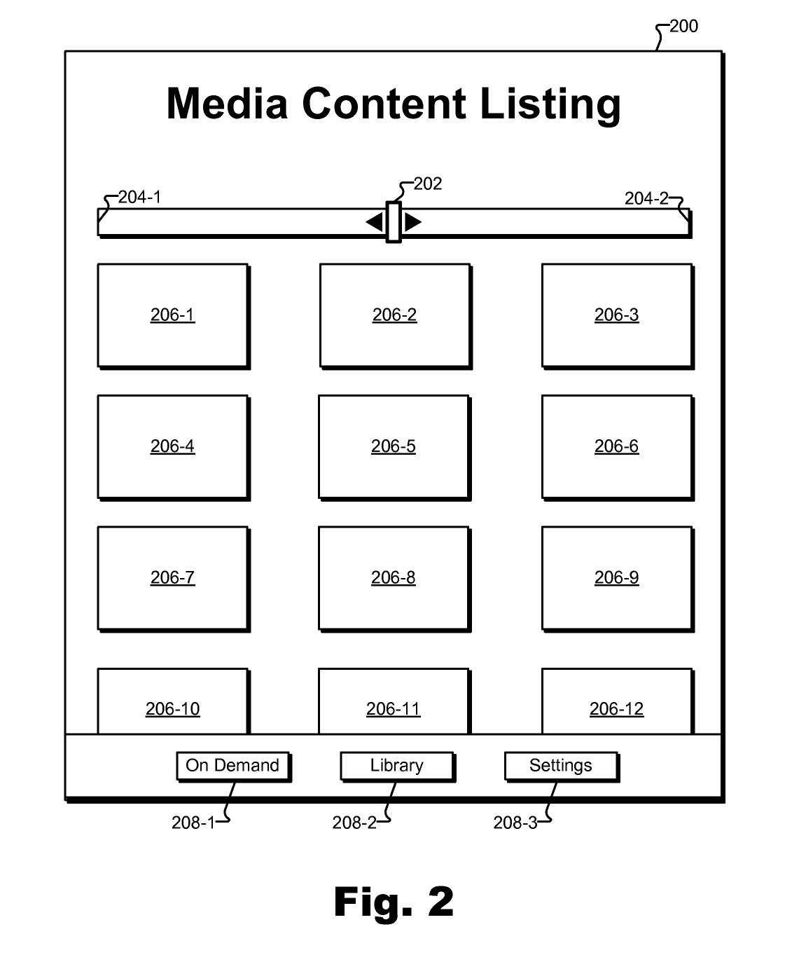

To illustrate, FIG. 2 shows an exemplary media content listing interface 200 that may be presented by presentation facility 102. As shown, a graphical depiction of a slider 202 disposed in between a first pole 204-1 and a second pole 204-2 (referred to collectively as “poles 204”) may be presented or displayed within media content listing interface 200. Slider 202 and poles 204 may be graphically depicted within media content listing interface 200 in any suitable manner. For example, as shown in FIG. 2, slider 202 may be graphically depicted as an analog-like slider and poles 204 may be depicted as opposite ends of a line upon which slider 202 is disposed. While slider 202 and poles 204 are shown in FIG. 2 to be arranged horizontally, it will be recognized that they may be arranged vertically or in any other manner as may serve a particular implementation.

As mentioned, poles 204 may each be representative of a particular media content characteristic. As used herein, a “media content characteristic” may refer to any trait, property, metadata value, or other characteristic of media content as may serve a particular implementation. For example, each pole 204 may be representative of a relative media content duration (e.g., first pole 204-1 may be representative of a relatively short media content duration and second pole 204-2 may be representative of a relatively long media content duration), a media content type or genre (e.g., first pole 204-1 may be representative of news and viral media content and second pole 204-2 may be representative of movies and shows), an emotion (e.g., first pole 204-1 may be representative of happy and cheerful media content and second pole 204-2 may be representative of sad and depressing media content), an access status (e.g., first pole 204-1 may be representative of media content that the user has already experienced or otherwise accessed and second pole 204-2 may be representative of media content that the user has not yet experienced or otherwise accessed), a relatedness to other media content that the user has experienced (e.g., first pole 204-1 may be representative of (or related to) media content that the user has already experienced and second pole 204-2 may be representative of new media content that the user has not experienced), and/or any other characteristic of media content as may serve a particular implementation.

In some examples, the first and second media content characteristics represented by first and second poles 204-1 and 204-2, respectively, are opposite in meaning one from another. For example, the first media content characteristic may be “happy” while the second media content characteristic may be “sad”. Additionally or alternatively, the first and second media content characteristics may define a range of media content characteristics in between the first and second media content characteristics. For example, the first pole 204-1 may be representative of media content instances that have a duration of thirty seconds or less while the second pole 204-2 may be representative of media content instances that have a duration of at least two hours. In this case, first and second poles 204-1 and 204-2 may define a range of media content durations in between thirty seconds and two hours. As will be described in more detail below, the first and second media content characteristics may be used to select media content instances for inclusion in a media content listing that is to be presented to a user.

In some examples, the media content characteristics represented by first and second poles 204-1 and 204-2 may be chosen, defined, or otherwise specified by a user. For example, media content management facility 104 may receive input representative of a designation by the user of the first and second media content characteristics and, in response to receiving the input, assign the first media content characteristic to first pole 204-1 and the second media content characteristic to second pole 204-2. To this end, one or more GUIs may be presented by presentation facility 102 that facilitate user designation of the first and second media content characteristics.

FIG. 2 further shows that a plurality of display elements 206 (e.g., display elements 206-1 through 206-12) may also be presented (e.g., concurrently with slider 202 and poles 204) within media content listing interface 200. Each display element 206 is representative of a particular media content instance included in a media content listing. For example, each display element 206 may be representative of a television program, movie, or video clip included in a watchlist, search results list, or other type of media content listing as may serve a particular implementation. As will be described below, the particular media content instances included in the media content listing represented by display elements 206 may be determined based on the position of slider 202 in between poles 204.

In the particular example of FIG. 2, each display element 206 is a selectable graphical object configured to facilitate access to its associated media content instance. For example, a particular display element (e.g., display element 206-1) may include a selectable movie poster, image, or other graphic representative of the display element's associated media content instance. A user may select the display element in order to access (e.g., play, experience, view, read about, listen to, etc.) the display element's associated media content instance. As will be illustrated below, each display element 206 may alternatively include text, animation content, a hyperlink, etc.

As shown in FIG. 2, media content listing interface 200 may additionally or alternatively include one or more options 208 (e.g. options 208-1 through 208-3) associated with the media content listing represented by display elements 206. A user may interact with options 208 in order to set one or more parameters associated with the media content listing, select one or more types of media content to be included within the media content listing, and/or perform any other suitable action with respect to the media content listing as may serve a particular implementation.

Returning to FIG. 1, media content management facility 104 may be configured to perform one or more media content management operations. For example, with respect to a graphical depiction of a slider disposed in between first and second poles representative of first and second media content characteristics, respectively, media content management facility 104 may determine, based on a position of the slider in between the first and second poles, a first weighted value for the first media content characteristic and a second weighted value for the second media content characteristic. Based on at least one of these weighted values, media content management facility 104 may select a subset of media content instances from a plurality of media content instances available for access by way of an access device for inclusion in a media content listing. Presentation facility 102 may then present display elements representative of the subset of media content instances selected for inclusion in the media content listing within the media content listing interface.

To illustrate, with respect to FIG. 2, media content management facility 104 may determine weighted values for (e.g., assign weighted values to) the first and second media content characteristics represented by first and second poles 204-1 and 204-2 based on a position of slider 202 in between first and second poles 204-1 and 204-2. In the example of FIG. 2, slider 202 is shown to be equidistant from both first and second poles 204. Hence, media content management facility 104 may assign equivalent weighted values to both the first and second media content characteristics.

Media content management facility 104 may utilize the determined weighted values to select a subset of media content instances from a plurality of media content instances available for access by way of an access device for inclusion in the media content listing shown in FIG. 2 in any suitable manner. For example, media content management facility 104 may select the media content instances for inclusion in the media content listing in accordance with a predetermined selection heuristic that is based in part on the determined weighted values. The predetermined selection heuristic may include any suitable selection heuristic as may serve a particular implementation.

To illustrate, media content management facility 104 may be configured to determine, based on the first and second weighted values, a ratio of media content instances that have the first media content characteristic and that are to be included in the media content listing to media content instances that have the second media content characteristic and that are to be included in the media content listing. Media content management facility 104 may then select, for inclusion within the media content listing, one or more media content instances that have the first media content characteristic and one or more media content instances that have the second media content characteristic in accordance with the determined ratio.

For example, if the weighted values corresponding to the first and second media content characteristics are equivalent, as in the example of FIG. 2, media content management facility 104 may determine that the ratio of media content instances that have the first media content characteristic and that are to be included in the media content listing to media content instances that have the second media content characteristic and that are to be included in the media content listing is 1:1. Hence, media content management facility 104 may select an equal number of media content instances that have the first media content characteristic and media content instances that have the second media content characteristic for inclusion in the media content listing.

As another example of a selection heuristic that may be used by media content management facility 104 to select media content instances for inclusion in a media content listing, media content management facility 104 may be configured to use the first and second weighted values to identify a particular media content characteristic included within a range of media content characteristics defined by the first and second media content characteristics. Media content management facility 104 may then select one or more media content instances that have the particular media content characteristic for inclusion in the media content listing.

For example, if first pole 204-1 is representative of a media content duration of thirty minutes and second pole 204-2 is representative of a media content duration of two hours, and if the weighted values corresponding to the first and second media content characteristics are equivalent, as in the example of FIG. 2, media content management facility 104 may select one or more media content instances that have durations of 75 minutes for inclusion in the media content listing.

It will be recognized that the selection heuristic utilized by media content management facility 104 to select media content instances for inclusion in the media content listing may additionally or alternatively be based on one or more other factors. For example, the selection heuristic may be further based on a search term provided by a user, a user profile associated with the user, a watchlist associated with the user, a time of day, one or more parental controls, etc. Moreover, it will be recognized that media content management facility 104 may be configured to determine whether a particular media content instance has a particular media content characteristic by analyzing one or more metadata values associated with the media content instance, third-party information describing one or more attributes of the media content instance, and/or any other information associated with the media content instance as may serve a particular implementation.

As mentioned, a user may interact with a graphical depiction of a slider in order to reposition the slider and thereby refine a media content listing presented within a media content listing interface. For example, a user may interact with slider 202 (e.g., by touching the graphical depiction of slider 202 and manually moving it to the right or to the left) in order to reposition slider 202 to a different position in between first and second poles 204-1 and 204-2. In response, media content management facility 104 may adjust the first and second weighted values corresponding to the first and second media content characteristics associated with first and second poles 204-1 and 204-2. Media content management facility 104 may then select a different subset of media content instances for inclusion in the media content listing based on the adjusted first and second weighted values. Presentation facility 102 may then transition from presenting display elements 206 within media content listing interface 200 to presenting a new set of display elements representative of the newly selected subset of media content instances within media content listing interface 200.

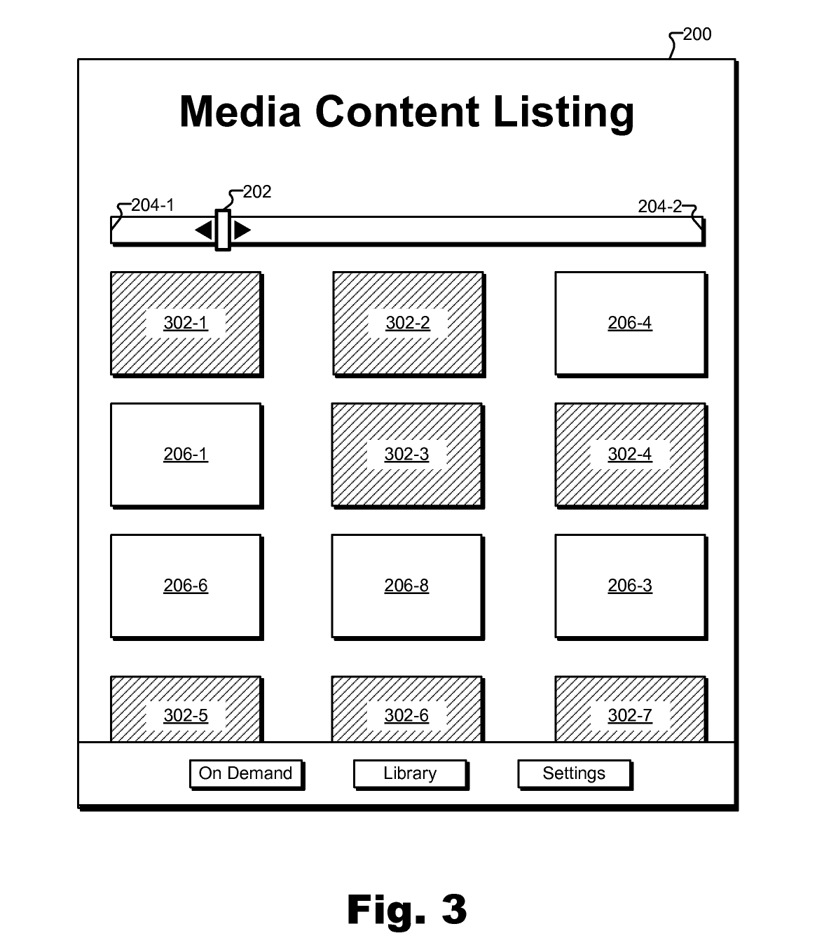

To illustrate, FIG. 3 shows media content listing interface 200 after a user has repositioned slider 202 to a position that is relatively closer to first pole 204-1 than to second pole 204-2. Because slider 202 is relatively closer to first pole 204-1 than to second pole 204-2, media content management facility 104 may set the first weighted value associated with the first media content characteristic to be greater than the second weighted value associated with the second media content characteristic and select a new subset of media content instances for inclusion in the media content listing based on the new weighted values.

FIG. 3 shows that presentation facility 102 has transitioned from presenting display elements 206-1 through 206-12 within media content listing interface 200 (as shown in FIG. 2) to presenting a new set of display elements (i.e., display elements 302-1 through 302-7 and display elements 206-1, 206-3, 206-4, 206-6, and 206-8) representative of the newly selected subset of media content instances. As illustrated in FIG. 3, one or more media content instances (e.g., the media content instances represented by display elements 206-1, 206-3, 206-4, 206-6, and 206-8) may be included in both the original media content listing shown in FIG. 2 and in the newly selected media content listing shown in FIG. 3. Alternatively (e.g., in cases where slider 202 is moved a relatively large distance from its original position), an entirely new set of media content instances may be selected for inclusion in the media content listing.

In some examples, the transition from the original media content listing to the new media content listing as illustrated in FIG. 3 may be performed dynamically as the user repositions slider 202. For example, as slider 202 is repositioned from one position to another, presentation facility may dynamically replace the originally presented display elements (i.e., display elements 206-1 through 206-12 shown in FIG. 2) with display elements representative of the newly selected media content instances (i.e., display elements 302-1 through 302-7 and display elements 206-1, 206-3, 206-4, 206-6, and 206-8 shown in FIG. 3). In some examples, one or more animation effects may be utilized to visually portray the dynamic transition.

In some examples, the position of each display element shown in media content listing interface 200 may also be determined in accordance with the weighted values of the first and second media content characteristics. For example, FIG. 3 shows that the positions of display elements 206-1, 206-3, 206-4, and 206-6 have been changed in response to the change in weighting values that resulted from the repositioning of slider 202.

While FIG. 3 shows media content listing interface 200 after a user has repositioned slider 202 to a position that is relatively closer to first pole 204-1 than to second pole 204-2, it will be recognized that the user may alternatively reposition slider 202 to a position that is relatively closer to second pole 204-2 than to first pole 204-1. In this case, media content management facility 104 may set the second weighted value associated with the second media content characteristic to be greater than the first weighted value associated with the first media content characteristic and select a new subset of media content instances for inclusion in the media content listing based on the new weighted values.

Returning to FIG. 1, storage facility 106 may be configured to maintain media content data 108 representative of and/or otherwise associated with one more media content instances accessible by way of an access device and/or media content characteristic data 110 representative of or otherwise associated with one or more media content characteristics. Storage facility 106 may maintain additional or alternative data as may serve a particular implementation.

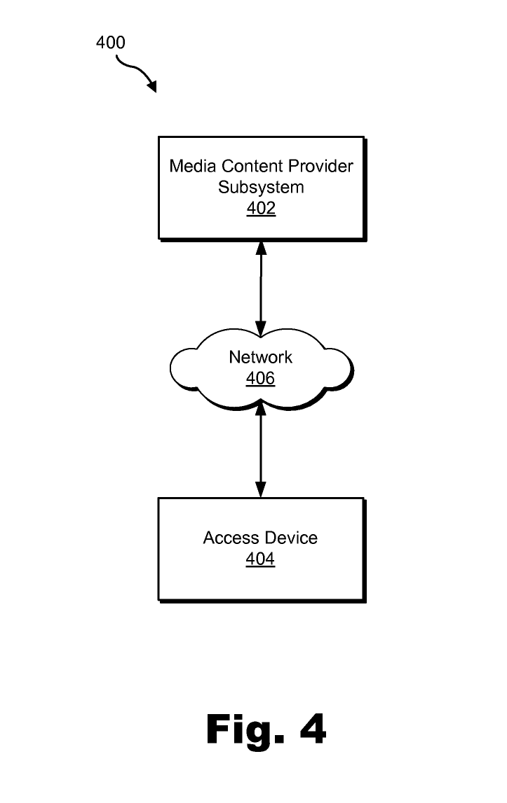

FIG. 4 illustrates an exemplary implementation 400 of system 100 in which a media content provider subsystem 402 (“provider subsystem 402”) is communicatively coupled to an access device 404 (or simply “access device 404”). As will be described in more detail below, presentation facility 102, media content management facility 104, and storage facility 106 may each be implemented by provider subsystem 402 and/or access device 404.

Provider subsystem 402 may be configured to generate or otherwise provide media content and/or data associated with media content (e.g., program guide data, etc.) to access device 404. For example, provider subsystem 402 may be implemented by one or more components (e.g., servers, computing devices, etc.) associated with a service provider (e.g., a subscriber television service provider, an Internet service provider, a wireless carrier, etc) that provides media content to one or more users (e.g., subscribers).

Access device 404 may be implemented by any suitable computing device. For example, access device 404 implemented by one or more set-top box devices, digital video recording (“DVR”) devices, mobile devices (e.g., smart phones, mobile phones, and/or tablet computers), personal computers, personal-digital assistant devices, gaming devices, television devices, etc. In some examples, access device 404 may be configured to facilitate access by a user to the media content and/or data associated with media content (e.g., data representative of a media content listing) received from provider subsystem 402. To this end, access device 404 may present the media content for experiencing (e.g., viewing) by a user, record the media content, and/or perform any other operation associated with the media content as may serve a particular implementation.

Provider subsystem 402 and access device 404 may communicate using any suitable communication technologies, devices, networks, media, and protocols supportive of remote data communications. For example, as shown in FIG. 4, provider subsystem 402 may be configured to communicate with access device 404 over a network 406 (and communications links thereto). Network 406 may include one or more networks or types of networks capable of carrying communications and/or data signals between provider subsystem 402 and access device 404. For example, network 406 may include, but is not limited to, a cable network, an optical fiber network, a hybrid fiber coax network, a wireless network (e.g., a Wi-Fi and/or mobile telephone network), a satellite network, a wireless broadcast network (e.g., a satellite media broadcasting network or terrestrial broadcasting network), a subscriber television network, a provider-specific network (e.g., a Verizon® FIOS® network), the Internet, an intranet, a local area network, any other suitable network, and any combination or sub-combination of these networks.

Provider subsystem 402 and access device 404 may communicate over network 406 using any suitable communication technologies, devices, media, and protocols supportive of remote data communications, including, but not limited to, data transmission media, communications devices, Transmission Control Protocol (“TCP”), Internet Protocol (“IP”), File Transfer Protocol (“FTP”), Telnet, Hypertext Transfer Protocol (“HTTP”), Real Time Protocol (“RTP”), User Datagram Protocol (“UDP”), Ethernet, and any other suitable communications technologies, devices, media, and protocols.

In certain embodiments, system 100 may be implemented entirely by provider subsystem 402 or by access device 404. In other embodiments, components of system 100 may be distributed across any combination of provider subsystem 402 and access device 404.

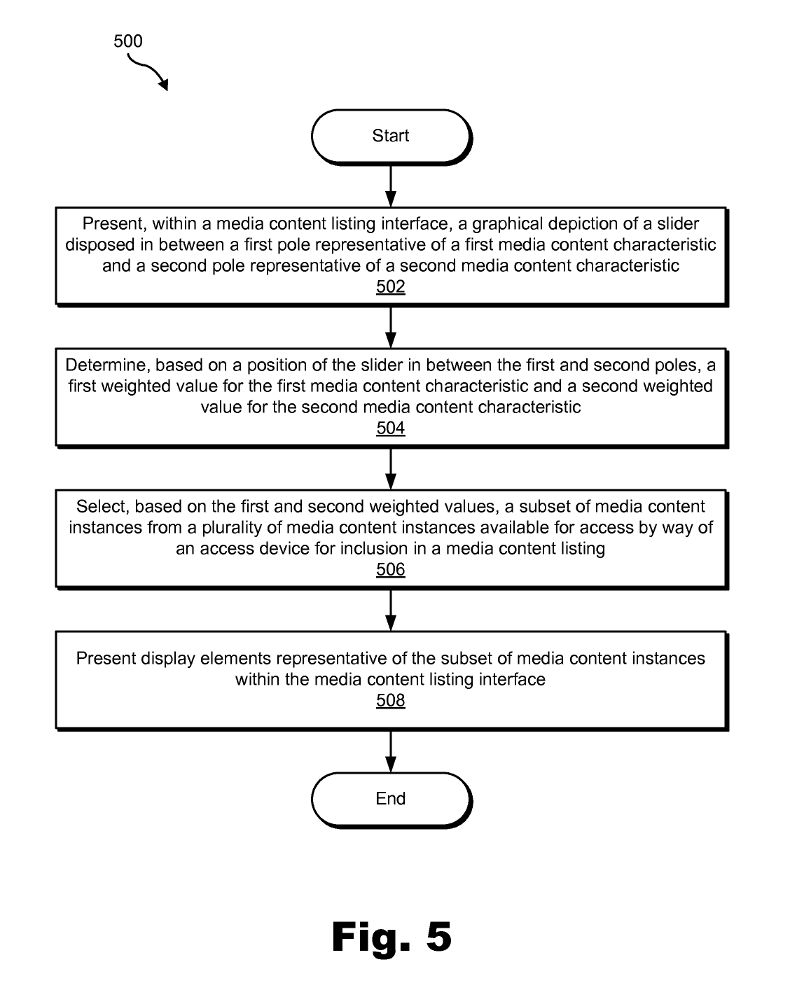

FIG. 5 illustrates an exemplary method 500 of facilitating user refinement of a media content listing. While FIG. 5 illustrates exemplary steps according to one embodiment, other embodiments may omit, add to, reorder, and/or modify any of the steps shown in FIG. 5. One or more of the steps shown in FIG. 5 may be performed by media content delivery system 100 and/or any implementation thereof.

In step 502, a media content delivery system presents, within a media content listing interface, a graphical depiction of a slider disposed in between a first pole representative of a first media content characteristic and a second pole representative of a second media content characteristic. Step 502 may be performed in any of the ways described herein.

In step 504, the media content delivery system determines, based on a position of the slider in between the first and second poles, a first weighted value for the first media content characteristic and a second weighted value for the second media content characteristic. Step 504 may be performed in any of the ways described herein.

In step 506, the media content delivery system selects, based on the first and second weighted values, a subset of media content instances from a plurality of media content instances available for access by way of an access device for inclusion in a media content listing. Step 506 may be performed in any of the ways described herein.

In step 508, the media content delivery system presents display elements representative of the subset of media content instances within the media content listing interface. Step 508 may be performed in any of the ways described herein.

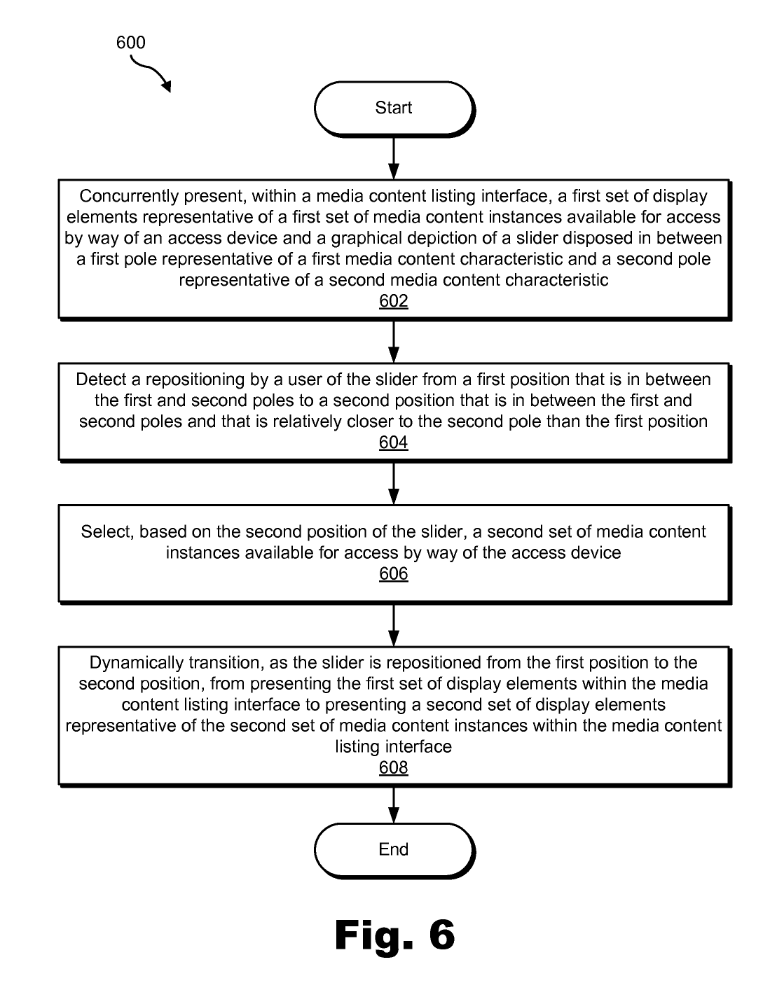

FIG. 6 illustrates another exemplary method 600 of facilitating user refinement of a media content listing. While FIG. 6 illustrates exemplary steps according to one embodiment, other embodiments may omit, add to, reorder, and/or modify any of the steps shown in FIG. 6. One or more of the steps shown in FIG. 6 may be performed by media content delivery system 100 and/or any implementation thereof.

In step 602, a media content delivery system concurrently presents, within a media content listing interface, a first set of display elements representative of a first set of media content instances available for access by way of an access device and a graphical depiction of a slider disposed in between a first pole representative of a first media content characteristic and a second pole representative of a second media content characteristic. Step 602 may be performed in any of the ways described herein.

In step 604, the media content delivery system detects a repositioning by a user of the slider from a first position that is in between the first and second poles to a second position that is in between the first and second poles and that is relatively closer to the second pole than the first position. Step 604 may be performed in any of the ways described herein.

In step 606, the media content delivery system selects, based on the second position of the slider, a second set of media content instances available for access by way of the access device. Step 606 may be performed in any of the ways described herein.

In step 608, the media content delivery system dynamically transitions, as the slider is repositioned from the first position to the second position, from presenting the first set of display elements within the media content listing interface to presenting a second set of display elements representative of the second set of media content instances within the media content listing interface. Step 608 may be performed in any of the ways described herein.

Various examples of media content listing interfaces that may be presented by system 100 will now be provided. It will be recognized that the examples provided herein are merely illustrative of the many examples that may be realized in accordance with the methods and systems described herein.

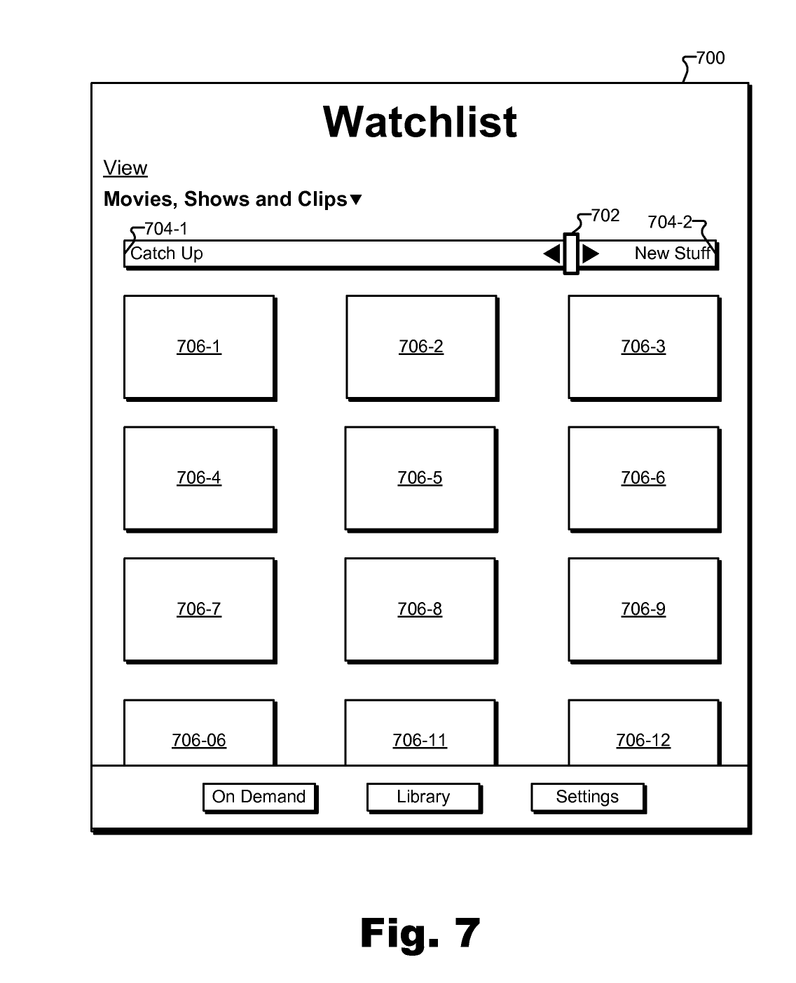

FIG. 7 illustrates an exemplary watchlist interface 700 that may be presented by system 100. As shown, watchlist interface 700 may include a graphical depiction of a slider 702 disposed in between a first pole 704-1 and a second pole 704-2 (referred to collectively as “poles 704”). In the example of FIG. 7, first pole 704-1 is representative of media content that is related to media content that the user has already experienced (e.g., episodes in a television series that the user likes to watch) and second pole 704-2 is representative of media content that the user has not yet experienced (e.g., newly available media content). As shown, each pole 704 may be labeled (e.g., first pole 704-1 is labeled “Catch Up” and second pole 704-2 is labeled “New Stuff”).

Watchlist interface 700 may also include a plurality of display elements 706 (e.g., display elements 706-1 through 706-12) each representative of a particular media content instance included in a watchlist associated with a user. As used herein, a “watchlist” may include media content instances selected or flagged for future access by a user, automatically selected by system 100 for presentation to the user based on a user profile and/or viewing history of the user, and/or otherwise selected for experiencing by the user.

As shown, slider 702 is positioned relatively closer to second pole 704-2 than to first pole 704-1. Hence, the second media content characteristic represented by second pole 704-2 is weighted higher than the first media content characteristic represented by first pole 704-1. In some examples, this may result in a majority of display elements 706 being representative of media content instances that the user has not yet experienced. To dynamically include more media content instances in the watchlist that are related to media content that the user has already experienced, the user may simply reposition slider 702 closer to first pole 704-1.

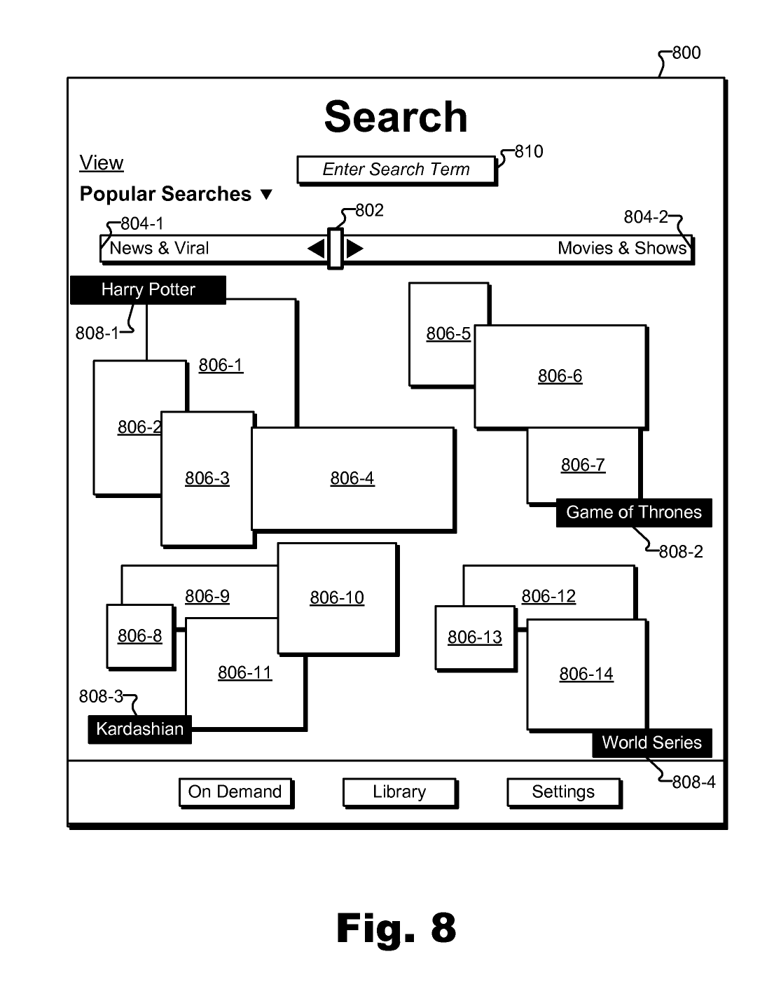

FIG. 8 illustrates an exemplary search results interface 800 that may be presented by system 100. As shown, search results interface 800 may include a graphical depiction of a slider 802 disposed in between a first pole 804-1 and a second pole 804-2 (referred to collectively as “poles 804”). In the example of FIG. 8, first pole 804-1 is representative of news and viral media content (e.g., news clips and viral YouTube videos) and second pole 804-2 is representative of movies and shows (e.g., on-demand movies, recorded television programs, etc.). As shown, each pole 804 may be labeled (e.g., first pole 804-1 is labeled “News & Viral” and second pole 804-2 is labeled “Movies & Shows”).

In the example of FIG. 8, the user has selected an option to view “popular searches” (i.e., searches performed by a relatively large number of other users). As a result, a search results listing associated with one or more of the popular searches may be presented within search results interface 800. For example, FIG. 8 shows that search results interface 800 may include display elements 806-1 through 806-4 representative of media content instances included in a search results listing associated with the search term “Harry Potter”, display elements 806-5 through 806-7 representative of media content instances included in a search results listing associated with the search term “Game of Thrones”, display elements 806-8 through 806-11 representative of media content instances included in a search results listing associated with the search term “Kardashian”, and display elements 806-12 through 806-14 representative of media content instances included in a search results listing associated with the search term “World Series”. Display elements 806-1 through 806-14 may be collectively referred to as “display elements 806”.

As shown, labels 808 (e.g., labels 808-1 through 808-4) indicating the particular search terms may be presented together with the different groups of display elements 806 presented within search results interface 800. In this manner, a user may readily ascertain which media content instances correspond to a particular search term.

In some examples, as shown in FIG. 8, the sizes and positions of display elements 806 may be set in order to indicate various properties of the media content instances represented by display elements 806. For example, featured media content instances (as determined by a media content provider, one or more users, or any other entity) may be represented by relatively large display elements (e.g., display element 806-4) that are positioned in front of (i.e., overlaid on top of) other display elements representing other media content instances included in the search results listings. In some examples, a media content provider may pay a service provider to designate a particular media content instance as being featured.

As shown, slider 802 is positioned relatively closer to first pole 804-1 than to second pole 804-2. Hence, the first media content characteristic represented by first pole 804-1 is weighted higher than the second media content characteristic represented by second pole 804-2. In some examples, this may result in a majority of display elements 806 being representative of news clips and viral videos as opposed to movies and shows. To dynamically include more movies and shows in the search results listing, the user may simply reposition slider 802 closer to second pole 804-2.

Additionally or alternatively, a user may enter one or search terms into field 810 in order to further refine the various search results listings shown in FIG. 8. For example, a user may enter the search term “baseball” into field 810 in order to filter the various search results listings shown in FIG. 8.

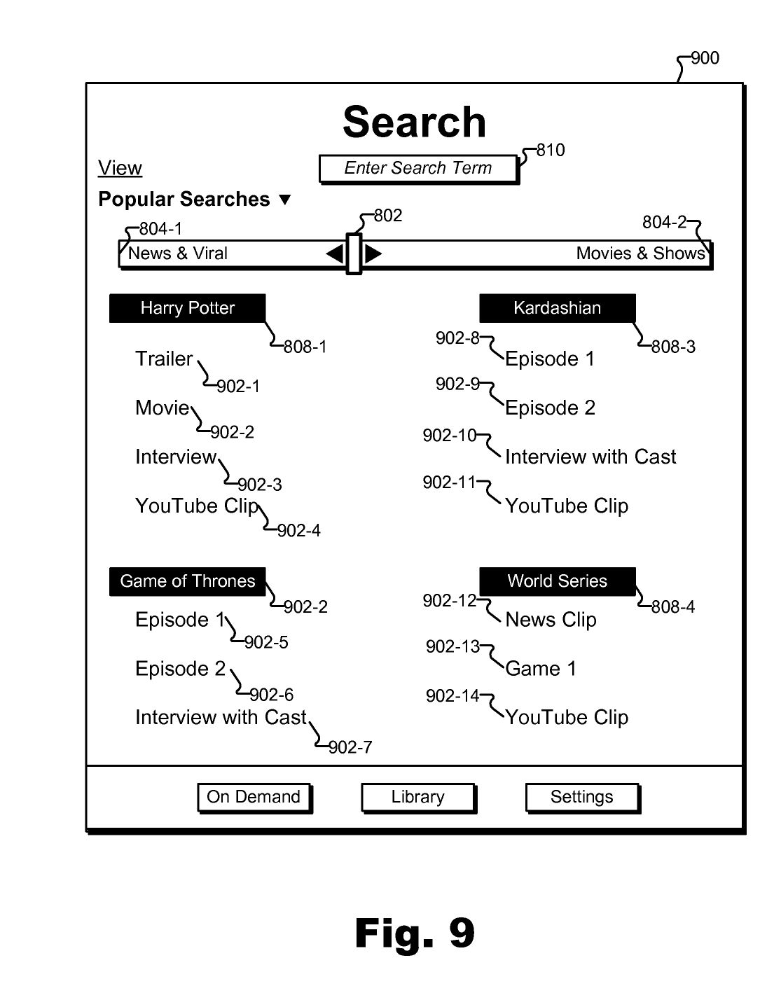

As mentioned, the display elements included in a particular media content listing interface may alternatively include text (as opposed to graphical objects). For example, FIG. 9 illustrates a search results interface 900 similar to search results interface 800, except that display elements 806-1 through 806-14 have been replaced with display elements 902-1 through 902-14 (collectively “display elements 902”). As shown, each display element 902 may include text descriptive of each respective media content instance included in the search results listings shown in search results interface 900.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

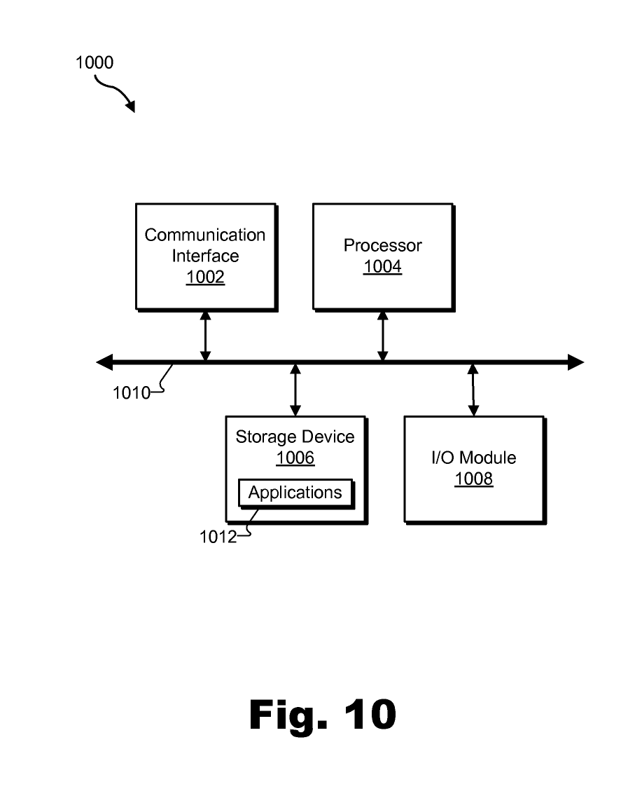

FIG. 10 illustrates an exemplary computing device 1000 that may be configured to perform one or more of the processes described herein. As shown in FIG. 10, computing device 1000 may include a communication interface 1002, a processor 1004, a storage device 1006, and an input/output (“I/O”) module 1008 communicatively connected via a communication infrastructure 1010. While an exemplary computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, an audio/video connection, and any other suitable interface.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1006. For example, data representative of one or more executable applications 1012 configured to direct processor 1004 to perform any of the operations described herein may be stored within storage device 1006. In some examples, data may be arranged in one or more databases residing within storage device 1006.

I/O module 1008 may be configured to receive user input and provide user output and may include any hardware, firmware, software, or combination thereof supportive of input and output capabilities. For example, I/O module 1008 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1008 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

In some examples, any of the systems, subsystems, and/or facilities described herein may be implemented by or within one or more components of computing device 1000. For example, one or more applications 1012 residing within storage device 1006 may be configured to direct processor 1004 to perform one or more processes or functions associated with presentation facility 102 and/or media content management facility 104. Likewise, storage facility 106 may be implemented by or within storage device 1006.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
presenting, by a media content delivery system within a media content listing interface, a graphical depiction of a slider disposed in between a first pole representative of a first media content characteristic and a second pole representative of a second media content characteristic;
determining, by the media content delivery system based on a position of the slider in between the first and second poles, a first weighted value for the first media content characteristic and a second weighted value for the second media content characteristic;
selecting, by the media content delivery system based on the first and second weighted values, a subset of media content instances from a plurality of media content instances available for access by way of an access device for inclusion in a media content listing; and
presenting, by the media content delivery system, display elements representative of the subset of media content instances within the media content listing interface.

2. The method of claim 1, further comprising:
detecting, by the media content delivery system, a repositioning by a user of the slider to a different position in between the first and second poles;
adjusting, by the media content delivery system in response to the repositioning of the slider to the different position, the first and second weighted values;
selecting, by the media content delivery system based on the adjusted first and second weighted values, a different subset of media content instances from the plurality of media content instances available for access by way of the access device for inclusion in the media content listing; and
transitioning, by the media content delivery system, from presenting the display elements representative of the subset of media content instances within the media content listing interface to presenting display elements representative of the different subset of media content instances within the media content listing interface.

3. The method of claim 2, wherein the transitioning comprises dynamically replacing, as the slider is repositioned to the different position, the display elements representative of the subset of media content instances with the display elements representative of the different subset of media content instances within the media content listing interface.

4. The method of claim 1, wherein the media content listing interface is presented on a display screen associated with the access device, and wherein the presenting of the graphical depiction of the slider disposed in between the first and second poles comprises directing the access device to present the graphical depiction of the slider disposed in between the first and second poles within the media content listing interface displayed on the display screen associated with the access device.

5. The method of claim 1, wherein the media content listing interface is presented on a display screen associated with the access device, and wherein the presenting of the display elements comprises directing the access device to present the display elements within the media content listing interface displayed on the display screen associated with the access device.

6. The method of claim 1, wherein the determining of the first and second weighted values comprises:
determining that the slider is positioned relatively closer to the first pole than to the second pole; and
setting, in response to the determining that the slider is positioned relatively closer to the first pole than to the second pole, the first weighted value associated with the first media content characteristic to be greater than the second weighted value associated with the second media content characteristic.

7. The method of claim 1, wherein the determining of the first and second weighted values comprises:
determining that the slider is positioned relatively closer to the second pole than to the first pole; and
setting, in response to the determining that the slider is positioned relatively closer to the second pole than to the first pole, the second weighted value associated with the second media content characteristic to be greater than the first weighted value associated with the first media content characteristic.

8. The method of claim 1, wherein the selecting of the subset of media content instances for inclusion in the media content listing comprises:
determining, based on the first and second weighted values, a ratio of media content instances that have the first media content characteristic and that are to be included in the media content listing to media content instances that have the second media content characteristic and that are to be included in the media content listing; and
selecting, for inclusion within the media content listing, one or more media content instances that have the first media content characteristic and one or more media content instances that have the second media content characteristic in accordance with the determined ratio.

9. The method of claim 1, wherein the first and second media content characteristics define a range of media content characteristics in between the first and second media content characteristics and wherein the selecting of the subset of media content instances for inclusion in the media content listing comprises:
using the first and second weighted values to identify a particular media content characteristic included within the range of media content characteristics; and
selecting one or more media content instances that have the particular media content characteristic for inclusion in the media content listing.

10. The method of claim 1, wherein the selecting of the subset of media content instances for inclusion in the media content listing is further based on at least one of a search term provided by a user, a user profile associated with the user, and a watchlist associated with the user.

11. The method of claim 1, wherein the first and second media content characteristics are opposite in meaning one from another.

12. The method of claim 1, wherein one or more of the display elements are selectable and configured to facilitate access to one or more media content instances included in the media content listing.

13. The method of claim 1, further comprising:
receiving, by the media content delivery system, input representative of a designation by a user of the first and second media content characteristics; and
assigning, by the media content delivery system in response to receiving the input, the first media content characteristic to the first pole and the second media content characteristic to the second pole.

14. The method of claim 1, embodied as computer-executable instructions on at least one non-transitory computer-readable medium.

15. A method comprising:
concurrently presenting, by a media content delivery system within a media content listing interface, a first set of display elements representative of a first set of media content instances available for access by way of an access device and a graphical depiction of a slider disposed in between a first pole representative of a first media content characteristic and a second pole representative of a second media content characteristic;
detecting, by the media content delivery system, a repositioning by a user of the slider from a first position that is in between the first and second poles to a second position that is in between the first and second poles and that is relatively closer to the second pole than the first position;
selecting, by the media content delivery system based on the second position of the slider, a second set of media content instances available for access by way of the access device; and
dynamically transitioning, as the slider is repositioned from the first position to the second position, from presenting the first set of display elements within the media content listing interface to presenting a second set of display elements representative of the second set of media content instances within the media content listing interface.

16. The method of claim 15, embodied as computer-executable instructions on at least one non-transitory computer-readable medium.

17. A system comprising:
a presentation facility configured to present, within a media content listing interface, a graphical depiction of a slider disposed in between a first pole representative of a first media content characteristic and a second pole representative of a second media content characteristic; and
a media content management facility communicatively coupled to the presentation facility and configured to
determine, based on a position of the slider in between the first and second poles, a first weighted value for the first media content characteristic and a second weighted value for the second media content characteristic, and
select, based on the first and second weighted values, a subset of media content instances from a plurality of media content instances available for access by way of an access device for inclusion in a media content listing;
wherein the presentation facility is further configured to present display elements representative of the subset of media content instances within the media content listing interface.

18. The system of claim 17, wherein:
the media content management facility is further configured to
detect a repositioning by a user of the slider to a different position in between the first and second poles,
adjust, in response to the repositioning of the slider to the different position, the first and second weighted values, and
select, based on the adjusted first and second weighted values, a different subset of media content instances from the plurality of media content instances available for access by way of the access device for inclusion in the media content listing; and
the presentation facility is further configured to transition from presenting the display elements representative of the subset of media content instances within the media content listing interface to presenting display elements representative of the different subset of media content instances within the media content listing interface.

19. The system of claim 18, wherein the presentation facility is configured to perform the transitioning by dynamically replacing, as the slider is repositioned to the different position, the display elements representative of the subset of media content instances with the display elements representative of the different subset of media content instances within the media content listing interface.

20. The system of claim 17, wherein the media content management facility is configured to select of the subset of media content instances for inclusion in the media content listing by:
determining, based on the first and second weighted values, a ratio of media content instances that have the first media content characteristic and that are to be included in the media content listing to media content instances that have the second media content characteristic and that are to be included in the media content listing; and
selecting, for inclusion within the media content listing, one or more media content instances that have the first media content characteristic and one or more media content instances that have the second media content characteristic in accordance with the determined ratio.
